(19) United States
(12) Patent Application Publication
(10) Pub. No.: US 2023/0130522 A1
(43) Pub. Date: Apr. 27, 2023

(54) Time Display and Image Projection Module

(71) Applicant: Kaijie Qiu, Dongguan (CN)

(72) Inventor: Kaijie Qiu, Dongguan (CN)

(21) Appl. No.: 17/512,620

(22) Filed: Oct. 27, 2021

(51) Int. Cl. G03B 21/14; G03B 21/00; G03B 21/20

(52) U.S. Cl. CPC G03B 21/145; G03B 21/006; G03B 21/2033

(57) ABSTRACT

The present invention provides a time display and image projection module involving the field of projection devices. The time display and image projection module comprises an upper casing and a bottom casing; a projector is installed between the two casings; the projector is provided with barrel structure, and an LCD screen is installed through the side wall of the projector. Through the integration of the upper casing, bottom casing, projector, PCB, LCD screen, light source component and amplification component, the LCD screen displays pictures on such small equipment as electronic alarm clock; the light source component and the amplification component enlarge and project pictures on the wall, ceiling and other places. The device has a compact structure particularly suitable for such small electronic equipment as electronic alarm clock, and is highly practical.

### TECHNICAL FIELD

The present invention relates to the technical field of projection devices, in particular to a time display and image projection module.

### BACKGROUND

A projection instrument means that its main part is a convergent projection lens, which converts the illuminated flat object into a magnified real image on the screen for many people to watch. This type of instrument can be called a projection instrument. Film projectors, slide projectors, printing magnifiers, and projectors for plotting, which are commonly used, all belong to these types of projection equipment.

With the development of modern science and technology, the existing projection instruments are becoming increasingly intelligent, which can be connected with existing computers, electronic alarm clocks and other equipment, and can project the corresponding images on the equipment on the wall or ceiling, and bring a good experience to home life. However, as most of the existing projection instruments have a large structure and size, they are not compact enough and are inconvenient for installation, especially when connected with electronic alarm clock and other equipment, which is inconvenient to operate and reduces the practicability of this kind of projection device. Therefore, we have designed a time display and image projection module to solve the above problems.

### SUMMARY

### Technical Problems to Be Solved

In view of the shortcomings of the prior art, the present invention provides a time display and image projection module, which solves the problems of the prior art that the projection instrument is large in size, the structure is not compact enough, and it is inconvenient to connect with small devices such as electronic alarm clocks.

### Technical Scheme

The present invention realizes the above purposes through the following technical scheme: the time display and image projection module comprises a upper casing, the bottom of which is provided with a bottom casing; a projector is installed between the upper casing and the bottom casing, and the projector is provided with barrel structure; an LCD screen is installed through the side wall of the projector; both sides of the projector are respectively embedded with an amplification component and a light source component; the amplification component and the light source component are respectively located on both sides of the LCD screen, and the amplification component is located at one end close to the opening of the upper casing; the upper surface of the bottom casing is fixedly connected with a PCB.

Preferably, the outer wall of the projector is provided with a through hole for the LCD screen.

Preferably, the light source component comprises a bracket fixed on the inner surface of the projector, and an LED lamp is embedded through the inner wall of the bracket.

Preferably, the amplification component comprises a bracket in contact with the inner surface of the projector, the inner wall of the bracket is embedded with the first magnifying glass, and the front side of the first magnifying glass is provided with a magnifying glass cover which is fixed on the inner surface of the bracket.

Preferably, the magnification component also includes the second magnifying glass, the second magnifying glass is fixed on the inner wall of the bracket, and the first magnifying glass is located between the magnifying glass cover and the second magnifying glass.

Preferably, the top of the upper case is provided with a mounting hole, the inner wall of which is rotatably connected with an adjusting wheel, and the bottom of the adjusting wheel runs through the projector and contacts with the bracket.

Preferably, the top of the projector is provided with a guide hole corresponding to the adjusting wheel, and the outer surface of the bracket is provided with a guide groove for the adjusting wheel, and the bottom of the adjusting wheel is in contact with the bottom of the guide groove.

Preferably, the cross-section of the upper casing is U-shaped. Preferably, a logic judgment module, a display module and a light source module are arranged in the PCB; the logic judgment module can determine the content to project and magnification factor according to the user's preset projection rules, and regulate the display module and light source module; the display module is used to display the content determined by the logic judgment module on the LCD screen according to a certain magnification factor and the instruction of the logic judgment module; the light source module is used to regulate the working state of the light source component according to the instructions of the logic judgment module.

Preferably, the user's preset projection rules include date, time and anniversary; the logic judgment module can determine the content to project and magnification factor according to the rules of date, time and anniversary; the PCB is also provided with a rule editing module and a networking module; the networking module supports networking function and allows remote calling of rule editing module; the rule editing module supports custom operation of projection rules.

### Beneficial Results

The present invention provides a time display and image projection module. It has the following beneficial effects:

1. Through the integration of the upper casing, bottom casing, projector, PCB, LCD screen, light source component and amplification component, the LCD screen displays pictures on such small equipment as electronic alarm clock; the light source component and the amplification component enlarge and project pictures on the wall, ceiling and other places. The device has a compact structure particularly suitable for such small electronic equipment as electronic alarm clock, and is highly practical.

2. Through the integration of the projector, the bracket, the first magnifying glass, the magnifying glass cover and the second magnifying glass, only the first magnifying glass or both the first and the second magnifying glass can be installed in the bracket as required, which can bring a different magnified projection and further increase the overall practicability of the device.

3. Through the integration of the upper and bottom casings, the projector, the bracket, the mounting hole, the adjusting wheel and the guide groove, the rotation of the adjusting wheel can drive the bracket to move in the projector. In this way, the spacing between the first magnifying glass and the LCD screen can be adjusted, and the viewing experience can be adjusted according to the projection distance, which offers better practicability and better user experience.

### BRIEF DESCRIPTION OF THE DRAWINGS

FIG. 1 Structural diagram of the embodiment 1 of the present invention;

FIG. 2 Exploded view of a the first magnifying glass mounted alone in embodiment 1 of the present invention;

FIG. 3 Exploded view of the first magnifying glass and the second magnifying glass mounted together in embodiment 1 of the present invention;

FIG. 4 Internal structural diagram of the projector in embodiment 1 of the present invention;

FIG. 5 Connection structural diagram of the bottom casing, the projector and the PCB in embodiment 1 of the present invention;

FIG. 6 Structural diagram of the embodiment 2 of the present invention;

FIG. 7 Exploded view of the first magnifying glass mounted alone in embodiment 2 of the present invention;

FIG. 8 Exploded view of the first magnifying glass and the second magnifying glass mounted together in embodiment 2 of the present invention;

FIG. 9 Diagram of the projection implementation method of the time display and image projection module of the present invention.

In which, 1. Upper casing; 2. Bottom casing; 3. Projector; 4. Bracket; 5. Bracket; 6. Magnifying glass cover; 7. First magnifying glass; 8. PCB; 9. LED lamp; 10. LCD screen; 11. Second magnifying glass; 12. Through hole; 13. Mounting hole; 14. Adjusting wheel; 15. Guide hole; 16. Guide groove.

### DETAILED DESCRIPTION

The technical scheme in the embodiment of the present invention will be clearly and completely described below in combination with the figures in the embodiment of the present invention. Obviously, the described embodiments are only a part of rather than all of the embodiments of the present invention. Based on the embodiments of the present invention, all other embodiments obtained by those skilled in the art without creative work belong to the protection scope of the present invention.

### Embodiment 1

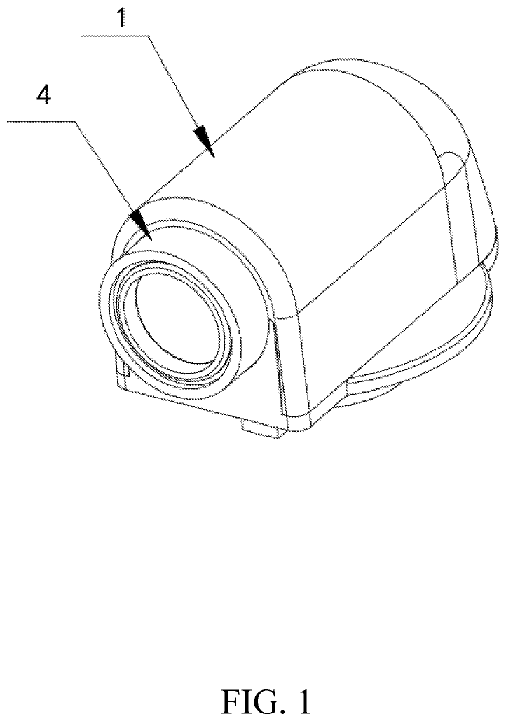

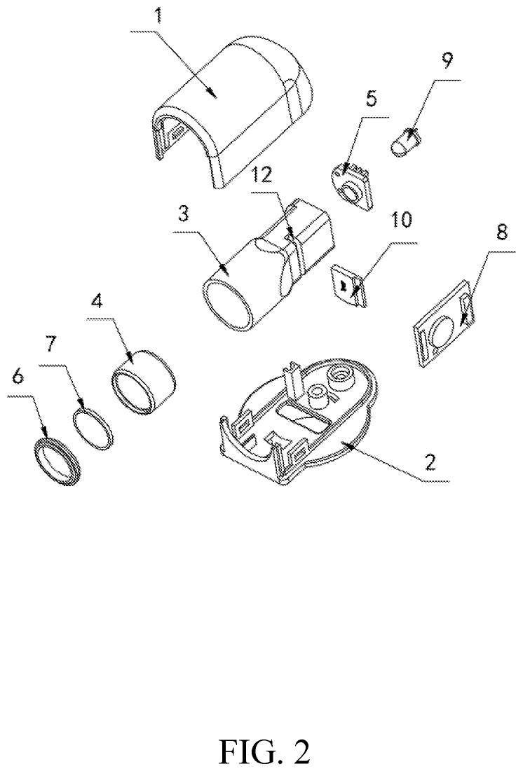

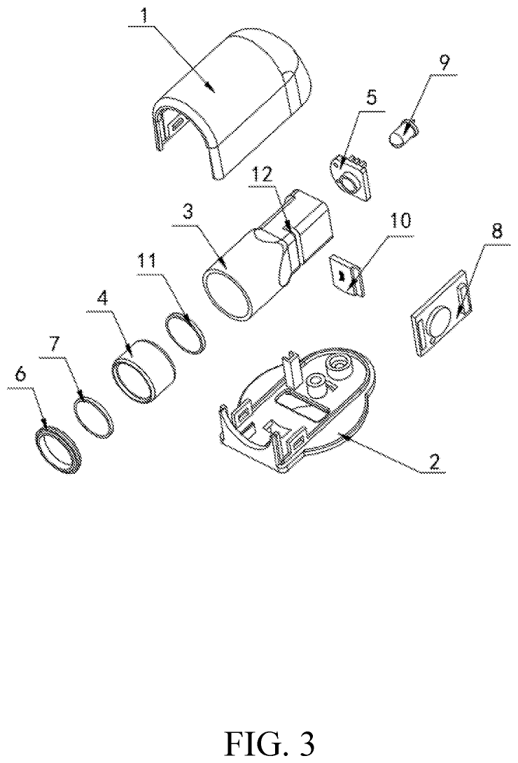

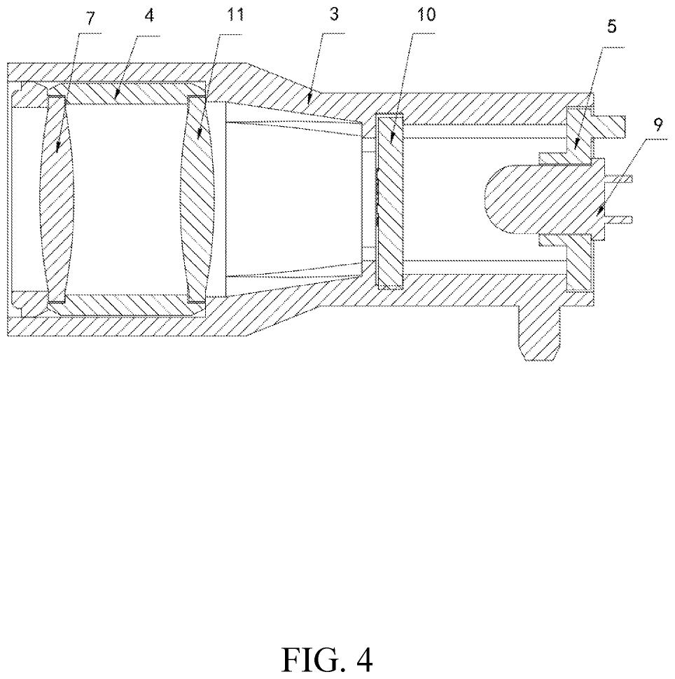

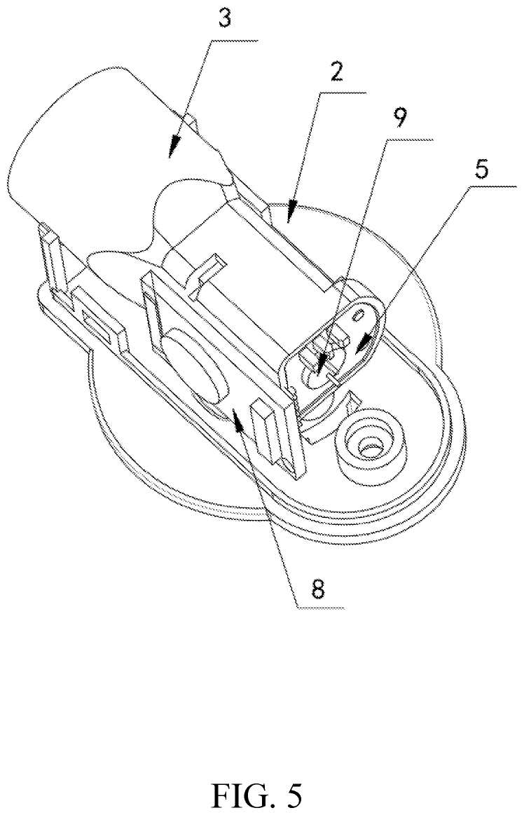

As shown in FIG. 1-5, the embodiment of the present invention provides a time display and image projection module, including the upper casing 1, and the cross-section of the upper casing 1 is arranged in a U-shape; a bottom casing 2 is clamped at the bottom of the upper casing 1, and a projector 3 is installed between the upper casing 1 and the bottom casing 2; the projector 3 is provided with barrel structure, and the side wall of the projector 3 is installed with an LCD screen 10; the outer wall of the projector 3 is provided with a through hole 12 for the LCD screen 10, so as to facilitate the insertion and installation of the LCD screen 10.

The two sides of the projector 3 are respectively embedded with an amplification component and a light source component. The amplification component and the light source component are respectively located on both sides of the LCD screen 10, and the amplification component is located at one end close to the opening of the upper casing 1. The upper surface of the bottom casing 2 is fixedly connected with a PCB 8, which is integrated with a circuit and electrically connected with the LCD screen 10, so as to control the LCD screen 10. The PCB 8 is connected with a flexible flat cable not shown in the figure, which is connected with an electronic alarm clock and other equipment, and the bottom casing 2 is provided with a wire hole to facilitate the passage of the flexible flat cable. The flexible flat cable is used to facilitate the connection of information of the electronic alarm clock and other equipment, so as to transmit pictures of the electronic alarm clock and other equipment to the LCD screen 10.

Specifically, the light source component includes a bracket 5 fixed on the inner surface of the projector 3, and the inner wall of the bracket 5 is embedded with an LED lamp 9; the amplification component comprises a bracket 4 in contact with the inner surface of the projector 3, and the inner wall of the bracket 4 is embedded with the first magnifying glass 7; the front side of the first magnifying glass 7 is provided with a magnifying glass cover 6, which is fixed on the inner surface of the bracket 4; the first magnifying glass 7 acts as a convex mirror to facilitate image projection; and the presence of the bracket 5 facilitates the installation of the LED lamp 9.

Further, the magnification component also includes the second magnifying glass 11, which is fixed on the inner wall of the bracket 4, and the first magnifying glass 7 is located between the magnifying glass cover 6 and the second magnifying glass 11; the user can select a product installed with the first magnifying glass 7 or a product installed with the first magnifying glass 7 together with the second magnifying glass 11 according to his or her own needs; the image projection of the two is different, which brings different visual experience to the user; meanwhile, the magnifying glass cover 6 plays a good protective role for the lens of the first magnifying glass 7 in the bracket 4, ensuring a long service life of the first magnifying glass 7.

Working principle: When in use, the cable is connected with such electronic equipment as an electronic alarm clock. When the power is turned on, the pictures on the electronic alarm clock and other equipment is transmitted to the PCB 8. The PCB 8 processes and transmits the signal to the LCD screen 10 and the LCD screen 10, which simultaneously displays the same picture as on the electronic equipment such as the electronic alarm clock. When the LED light 9 is on, the light of the LED light 9 shines on the LCD screen 10. After passing through the LCD screen 10, the light beam emitted by the LED lamp 9 passes through the first magnifying glass 7 or the first magnifying glass 7 together with the second magnifying glass 11, so as to project pictures on the LCD screen 10 outward and complete one projection.

### Embodiment 2

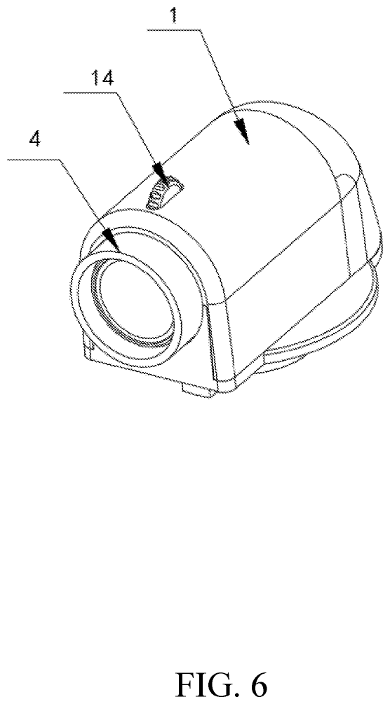

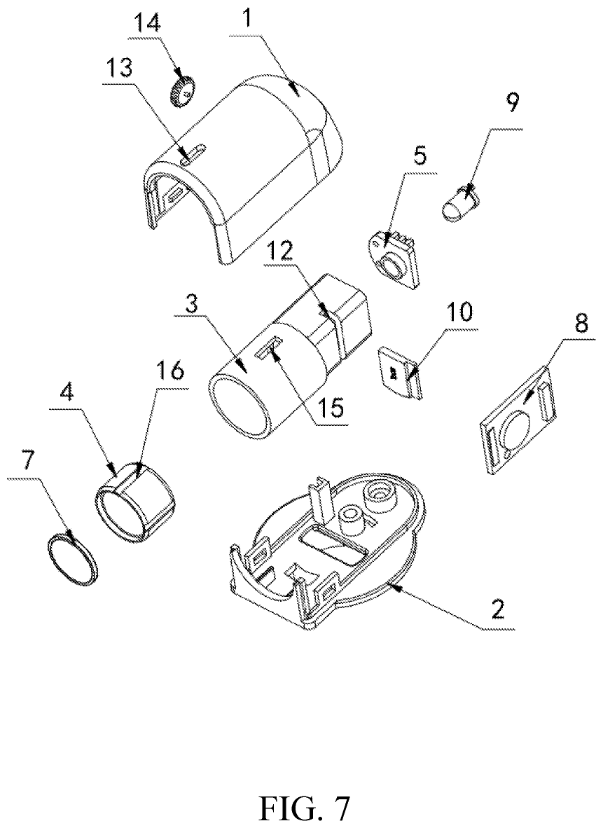

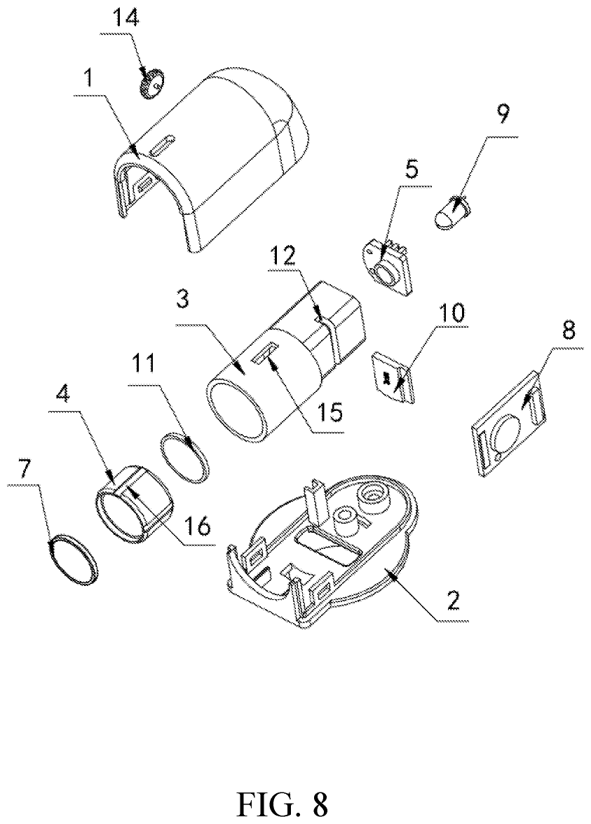

As shown in FIG. 6-8, this embodiment is based on embodiment 1: the top of the upper casing 1 is provided with a mounting hole 13, the inner wall of the mounting hole 13 is rotatably connected with an adjusting wheel 14, and the bottom of the adjusting wheel 14 runs through the projector 3 and contacts with the bracket 4; the top of the projector 3 is provided with a guide hole 15 corresponding to the adjusting wheel 14, the outer surface of the bracket 4 is provided with a guide groove 16 for the adjusting wheel 14, and the bottom of the adjusting wheel 14 is in contact with the bottom of the guide groove 16; When in use, by rotating the adjusting wheel 14, the adjusting wheel 14 can drive the overall fine adjustment of the bracket 4 under the action of friction, which can adjust the spacing between the bracket 4 and the LCD screen 10 so as to change the spacing between the first magnifying glass 7 and the LCD screen 10 in the bracket 4; in this way, different effects will be produced for different projection heights or lengths, which is highly practical and can bring the user a better experience. The projection working principle is the same as that of embodiment 1; therefore it will not be repeated here.

### Embodiment 3

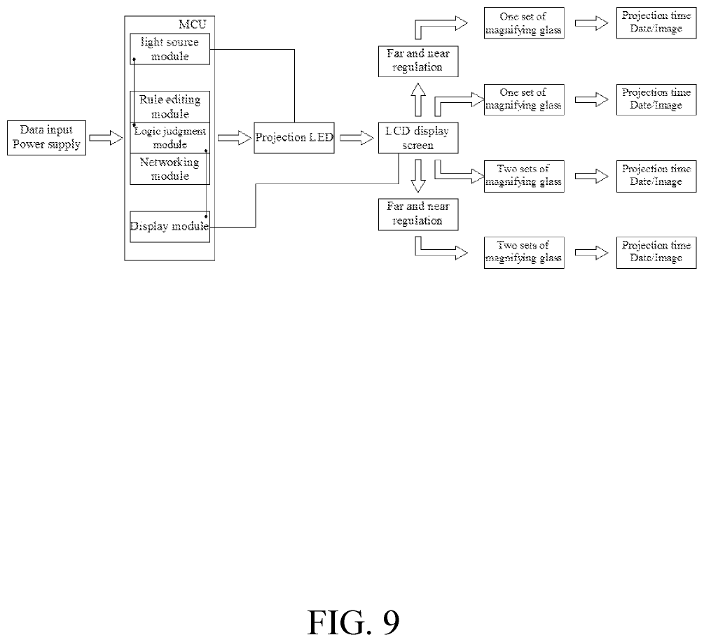

As shown in FIG. 9, this embodiment shows the projection implementation method of the time display and image projection module. The MCU of PCB 8 is provided with logic judgment module, display module, light source module, rule editing module and networking module.

The logic judgment module can determine the content to project and magnification factor according to the user's preset projection rules, and regulate the display module and the light source module. The display module is used to display the content determined by the logic judgment module on the LCD screen (10) according to a certain magnification factor and the instruction of the logic judgment module; the light source module is used to regulate the working state of the light source component according to the instruction of the logic judgment module. The networking module supports the networking function of time display and image projection module, allows remote access to time display and image projection module and calls the rule editing module. The rule editing module supports user-defined operation of the projection rules. The user's preset projection rules include but are not limited to date, time and anniversary, etc.; and the logic judgment module can determine the content to project and magnification according to the rules of date, time and anniversary.

The logic judgment module starts projection at the specified time according to the preset projection rules, and adjusts the color, brightness, picture content and picture size of the projected image through the light source module and the display module. The user can also set the device to start projection of the specified image on a specific date and time, and can also set the device to generate the projection of different pictures seven days a week, and put in different contents at different times of the day. The user can also customize projected content, such as images, text, or video. For example, the projection of the corresponding blessing picture is put on the birthday, wedding anniversary and other dates of relatives; through the networking module, the user can also remotely connect to the rule editing module and set custom projection rules to create surprises for relatives at home. For example, husbands on business travel can remotely customize such text or image content as “Dad loves you” on their children's birthday.

It should be noted that in this paper, such relational terms as the first and the second are only used to distinguish one entity or operation from another entity or operation, and do not necessarily require or imply any such actual relationship or order between these entities or operations. Moreover, the terms “include”, “comprise” or any other variations thereof are intended to cover non-exclusive inclusion, so that a process, method, article or equipment include not only those elements but also include other elements not explicitly recited, or also include the elements inherent to such process, method, article or equipment. Without further restrictions, the elements defined by the statement “including a reference structure” do not exclude the existence of other same elements in the process, method, article or equipment that includes the elements.

Although the embodiments of the present invention have been shown and described, it will be understood to those skilled in the art that a variety of changes, modifications, substitutions and modifications can be made to these embodiments without departing from the principle and spirit of the present invention, and the scope of the present invention is limited by the appended claims and their equivalents.

I claim:

1. The time display and image projection module comprises a upper casing (1), wherein the bottom of the upper casing (1) is clamped with a bottom casing (2); a projector (3) is installed between the upper casing (1) and the bottom casing (2), and the projector (3) is provided with barrel structure; an LCD screen (10) is installed through the side wall of the projector (3); both sides of the projector (3) are respectively embedded with an amplification component and a light source component; the amplification component and the light source component are respectively located on both sides of the LCD screen (10), and the amplification component is located at one end close to the opening of the upper casing (1); a PCB (8) is connected to the upper surface of the bottom casing (2).

2. The time display and image projection module as claimed in claim 1 is characterized in that the outer wall of the projector (3) is provided with a through hole (12) for the LCD screen (10).

3. The time display and image projection module as claimed in claim 1 is characterized in that the light source component comprises a bracket (5) fixed on the inner surface of the projector (3), and the inner wall of the bracket (5) is embedded with an LED lamp (9).

4. The time display and image projection module as claimed in claim 1 is characterized in that the amplification component comprises a bracket (4) in contact with the inner surface of the projector (3), the inner wall of the bracket (4) is embedded with the first magnifying glass (7), the front side of the first magnifying glass (7) is provided with a magnifying glass cover (6), which is fixed on the inner surface of the bracket (4).

5. The time display and image projection module as claimed in claim 4 is characterized in that the amplification component further comprises the second magnifying glass (11), which is fixed on the inner wall of the bracket (4), and the first magnifying glass (7) is located between the magnifying glass cover (6) and the second magnifying glass (11).

6. The time display and image projection module as claimed in claim 4 is characterized in that the top of the upper casing (1) is provided with a mounting hole (13), the inner wall of which is rotatably connected with an adjusting wheel (14), the bottom of which passes through the projector (3) and contacts with the bracket (4).

7. The time display and image projection module as claimed in claim 5 is characterized in that the top of the projector (3) is provided with a guide hole (15) corresponding to the adjusting wheel (14), the outer surface of the bracket (4) is provided with a guide groove (16) suitable for the adjusting wheel (14), the bottom of which is in contact with the bottom of the guide groove (16).

8. The time display and image projection module as claimed in claim 1 is characterized in that the cross-section of the upper casing (1) is arranged in a U-shape.

9. The time display and image projection module as claimed in claim 1 is characterized in that a logic judgment module, a display module and a light source module are arranged in the PCB (8);
The said logic judgment module can determine the content to project and magnification factor according to the user's preset projection rules, and regulate the display module and the light source module;
The said display module is used to display the content determined by the logic judgment module on the LCD screen (10) based on a certain magnification factor according to the instruction of the logic judgment module;
The said light source module is used to regulate the working state of the light source component according to the instruction of the logic judgment module.

10. The time display and image projection module as claimed in claim 9 is characterized by:
The said user's preset projection rules include date, time and anniversary;
The said logic judgment module can determine the content to project and magnification factor according to the rules of date, time and anniversary;
The said PCB (8) is also provided with a rule editing module and a networking module; the networking module supports the networking function and allows remote calling of the rule editing module;
